(19) United States
(12) Patent Application Publication
(10) Pub. No.: US 2021/0397167 A1
(43) Pub. Date: Dec. 23, 2021

(54) PROCESS IMPROVEMENT SUPPORT DEVICE, PROCESS IMPROVEMENT SUPPORT METHOD, AND RECORDING MEDIUM STORING PROCESS IMPROVEMENT SUPPORT PROGRAM

(71) Applicant: NEC Corporation, Minato-ku, Tokyo (JP)

(72) Inventor: Kenji ODA, Tokyo (JP)

(73) Assignee: NEC Corporation, Minato-ku, Tokyo (JP)

(21) Appl. No.: 17/421,357

(22) PCT Filed: Jan. 17, 2020
(86) PCT No.: PCT/JP2020/001411

§ 371 Date: Jul. 7, 2021

(30) Foreign Application Priority Data
Jan. 17, 2019 (JP) 2019-005920

(51) Int. Cl. G05B 19/418

(52) U.S. Cl. CPC G05B 19/41865; G05B 2219/32015

(57) ABSTRACT

A process improvement support device according to an aspect of the present disclosure includes: at least one memory configured to store instructions; and at least one processor configured to execute the instructions to: accumulate cycle times of a plurality of processes in a production line over a predetermined period; calculate a cycle time distribution that is a distribution of the cycle times of each of the processes in the predetermined period; and generate information for evaluating a correlation between the cycle time distribution of a first process and the cycle time distribution of a second process.

### TECHNICAL FIELD

The present disclosure relates to a process improvement support device and a process improvement support method.

### BACKGROUND ART

In an industrial product production line, it is common to finish a product by sequentially adding work in a plurality of processes. In the case of such a production line, when one work time of each process, that is, a cycle time has the same length, workpieces smoothly flow through the production line without stagnation. On the other hand, when the cycle time varies, the workpieces stagnate, and the production capacity of the entire line decreases. In such a case, it is important to quickly find a bottleneck process that causes the variation in the cycle time and improve the cycle time of the process. Therefore, a method for quickly finding the bottleneck process has been studied.

For example, PTL 1 discloses a method of finding a bottleneck process by comparing measured values with reference values with reference to a standard work time of each process and an allowable number of workpieces of an inlet buffer. In this method, the time from completion of a previous work to completion of a current work is measured as actual work time and compared with the reference value. Furthermore, the number of workpieces stocked in the buffer before the inlet of a certain process is measured and compared with the reference value.

In addition, PTL 2 discloses a method of finding a bottleneck process using a relationship between a distribution of lead times of all workpieces and a distribution of work times of each process. In this method, first, the distribution of lead times of all the workpieces is calculated. Next, an improvement target range is set within a range larger than an average value and smaller than a maximum value of all the lead times of all the workpieces. Then, a process strongly correlated to the improvement target range is extracted as an improvement required process (bottleneck process).

### CITATION LIST

### Patent Literature

[PTL 1] JP 05-192852 A

[PTL 2] JP 2006-202255 A

### SUMMARY OF INVENTION

### Technical Problem

However, in the technique of PTL 1, although the bottleneck process can be found out and the process can be improved but the effect of improving the overall efficiency may be small or may be adversely deteriorated. This is because a process with the cycle time affected by a previous process may exist among the plurality of processes. In the case of the process depending on the previous process, even if the process is tried to be improved alone, the effect may be small or a search for another process that is a principal cause of a delay may be separately required, and there is a possibility of occurrence of a so-called whack-a-mole state. Furthermore, in PLT 2, since the bottleneck process is found alone, there is a similar problem.

The present disclosure has been made in view of the above problems, and an object of the present disclosure is to provide a process improvement support device that specifies a bottleneck process for which an improvement effect would be substantial.

### Solution to Problem

To solve the above problems, a process improvement support device includes a cycle time accumulation means, a cycle time distribution calculation means, and a cycle time distribution correlation evaluation support means. The cycle time accumulation means accumulates cycle times of a plurality of processes constituting a production line over a predetermined period. The cycle time distribution calculation means calculates a distribution of each process in the predetermined period accumulated in the cycle time accumulation means as a cycle time distribution of the process. The cycle time distribution correlation evaluation support means generates information for evaluating a correlation between the cycle time distribution of a certain process (first process) and the cycle time distribution of another process (second process).

### Advantageous Effects of Invention

An effect of the present disclosure is to provide a process improvement support device that specifies a bottleneck process for which an improvement effect would be substantial.

### BRIEF DESCRIPTION OF DRAWINGS

FIG. 1 is a block diagram illustrating a process improvement support device according to a first example embodiment.

FIG. 2 is a block diagram illustrating a process improvement support device according to a second example embodiment.

FIG. 3 is a flowchart illustrating an operation of the process improvement support device according to the second example embodiment.

FIG. 4 is a flowchart illustrating another operation of the process improvement support device according to the second example embodiment.

FIG. 5 is a graph illustrating a display example according to the second example embodiment.

FIG. 6 is a flowchart illustrating a time-series display operation according to the second example embodiment.

FIG. 7 is a graph illustrating an example of time-series display according to the second example embodiment.

FIG. 8 is a schematic diagram illustrating a concept of bottleneck process extraction according to the second example embodiment.

FIG. 9 is a graph illustrating an improvement example of the second example embodiment.

FIG. 10 is a block diagram illustrating a process improvement support device according to a third example embodiment.

FIG. 11 is a flowchart illustrating an operation of the process improvement support device according to the third example embodiment.

### EXAMPLE EMBODIMENT

Hereinafter, example embodiments of the present disclosure will be described in detail with reference to the drawings. Note that the example embodiments to be described below have technically favorable limitations for implementing the present disclosure. However, the scope of the disclosure is not limited to below. The same reference numerals are given to similar constituent elements in the drawings, and description of the similar constituent elements may be omitted.

### First Example Embodiment

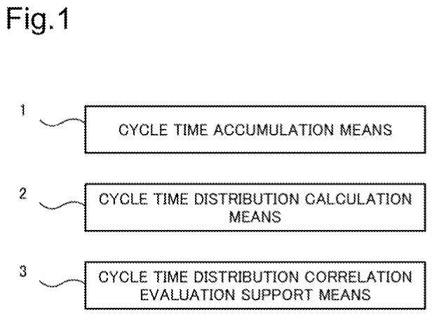

FIG. 1 is a block diagram illustrating a process improvement support device according to the present example embodiment. The process improvement support device includes a cycle time accumulation means 1, a cycle time distribution calculation means 2, and a cycle time distribution correlation evaluation support means 3.

The cycle time accumulation means 1 accumulates cycle times measured in a plurality of processes constituting a production line over a predetermined period.

The cycle time distribution calculation means 2 calculates a distribution of each process in the predetermined period accumulated in the cycle time accumulation means 1 as a cycle time distribution of the process.

The cycle time distribution correlation evaluation support means 3 generates information for evaluating a correlation between the cycle time distribution of a certain process (first process) and the cycle time distribution of another process (second process).

According to the process improvement support device of the present example embodiment, the information for evaluating the correlation between the cycle time distributions of the first process and the second process is generated, whereby an evaluation as to whether there is a correlation between the cycle time of the first process and the cycle time of the second process can be supported.

### Second Example Embodiment

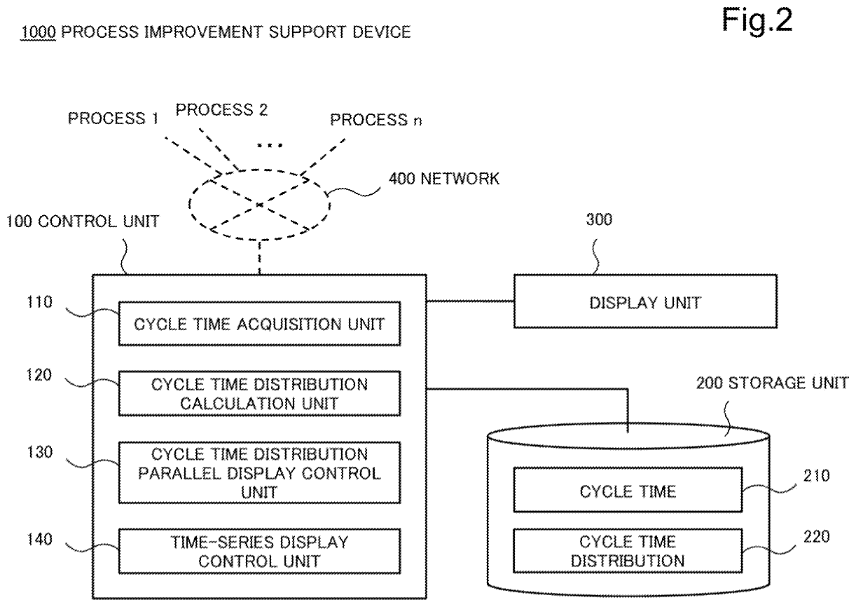

FIG. 2 is a block diagram illustrating a process improvement support device 1000 according to a second example embodiment. The process improvement support device 1000 includes a control unit 100, a storage unit 200, and a display unit 300. As specific hardware, for example, the control unit 100 can be a general computer, the storage unit 200 can be a general storage, and the display unit 300 can be a display such as a liquid crystal display device.

The control unit 100 includes a cycle time acquisition unit 110, a cycle time distribution calculation unit 120, a cycle time distribution parallel display control unit 130, and a time-series display control unit 140.

The cycle time acquisition unit 110 acquires the cycle time of each process from a network 400. The acquired cycle time is stored in the storage unit 200 as a cycle time 210. The cycle time 210 is accumulated as data holding time information for each measurement. Although any method of measuring the cycle time in each process can be used, for example, a known method such obtaining a work start time and a work completion time as inputs by reading a barcode attached on a workpiece, and adopting a difference time between the work start time and the work completion time as the cycle time can be used.

The cycle time distribution calculation unit 120 reads a plurality of cycle times in a predetermined period from the storage unit 200 and calculates a cycle time distribution in the predetermined period. Here, the distribution means a distribution of frequencies of the cycle time corresponding to a predetermined time interval. As will be described below, the distributions of the cycle times can be visualized as a histogram or a bubble chart. A calculated cycle time distribution 220 is stored in the storage unit 200.

The cycle time distribution parallel display control unit 130 performs control to display the calculated cycle time distributions of the processes side by side on the display unit 300. Displaying the cycle time distributions of a series of processes side by side enables visual evaluation of similarity among the distributions.

The time-series display control unit 140 performs control to display the cycle time distributions calculated at different times side by side at predetermined time intervals or sequentially switch and display the cycle time distributions as an animation.

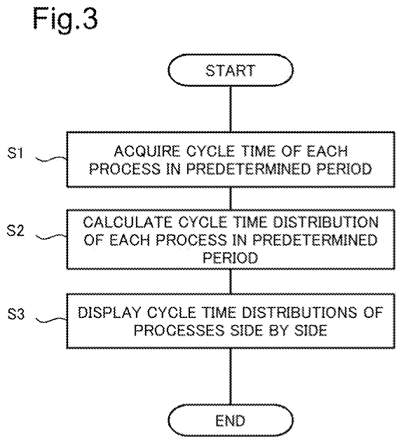

Next, the operation of the process improvement support device 1000 will be described. First, the simplest method will be described. FIG. 3 is a flowchart illustrating this operation. First, the cycle time of each process in a predetermined period is acquired (S1). Next, the cycle time distribution of each process in a predetermined period is calculated (S2). In the production line, since the workpiece is sequentially processed in a plurality of processes, strictly, there is a time lag at which the same workpiece is processed in the order of the processes. If the cycle time is sufficiently shorter than the period for calculating the distribution, sufficient evaluation can be performed even if the difference is ignored. Next, the cycle time distributions of the processes are displayed side by side (S3). Note that, in the above description, the distribution of the cycle times is calculated in the predetermined period but the distribution of the cycle times can also be calculated using the predetermined number of workpieces processed in the process.

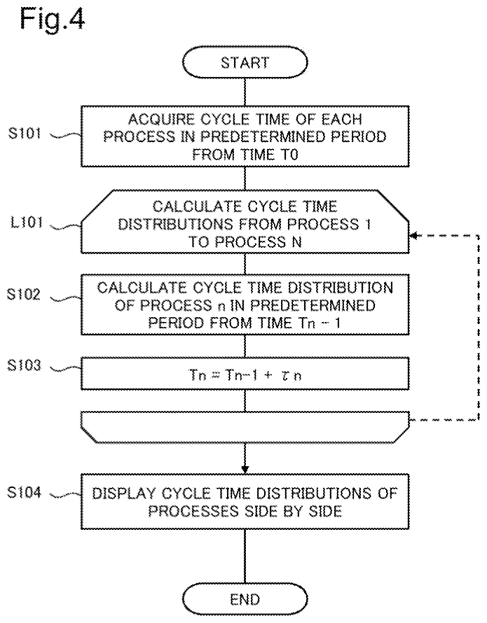

Next, an operation in the case of considering the time difference sent to the process will be described. FIG. 4 is a flowchart illustrating this operation. The number of processes is N (n=1 to N). First, the cycle time of each process in a predetermined period from time T0 is acquired (S101). Next, the cycle time distributions from the process 1 to the process N are calculated by the following loop process (L101). In this loop processing, first, the cycle time distribution of the process 1 in the predetermined period from the time T0 is calculated (S102). Next, τ1 is added to the time T0 to calculate time T1 (S103). Next, the processing returns in the loop, and the cycle time distribution of the process 2 in a predetermined period from the time T1 is calculated (S102). Next, τ2 is added to the time T1 to calculate time T2 (S103). Such processing is repeated until the cycle time distribution calculation of the process N is completed. τ1, τ2, or the like used above can be, for example, a constant of a standard cycle time. Furthermore, for example, an average value of the cycle times of the process n may be used as in. Next, the calculated cycle time distributions of the processes are displayed side by side (S104). By performing the above calculation, the cycle time distributions can be compared in consideration of the passage order of the processes. Note that, in the above description, the distribution of the cycle times is calculated in the predetermined period but the distribution of the cycle times can also be calculated using the predetermined number of workpieces processed in the process.

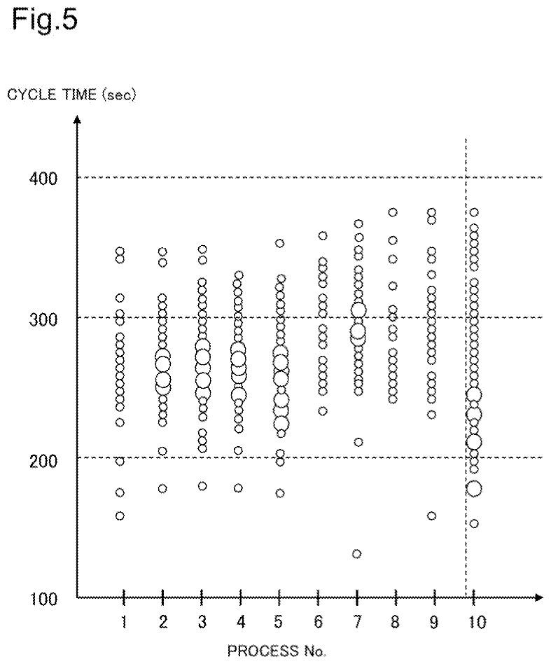

FIG. 5 is a graph illustrating an example of displaying the cycle time distributions of the processes calculated by the above-described method side by side. The cycle time distributions of one process are represented by a bubble chart. That is, the frequency for each time segment is represented by the size of a circle. From the viewpoint of cycle time balance, it is ideal that the bubble chart of each process has a large circle near the standard value of the cycle time, and there is a problem when there are many distributions on the side where the cycle time is longer than the standard value. By the way, in the present example embodiment, since the correlation among the processes is desired to be evaluated, the similarity of the shapes of the adjacent bubble charts is evaluated. For example, in a case where the standard value of the cycle time of a certain process is not appropriate, defects frequently occur in the process, so that the number of distributions on the side where the cycle time is longer than the standard value becomes larger than the number of distributions on the side where the cycle time is shorter than the standard value. Then, in the next process of the certain process, the number of distributions on the side where the cycle time is longer than the standard value becomes larger than the number of distributions on the side where the cycle time is shorter than the standard value due to the influence of the defects in the previous certain process. For example, in FIG. 5, when the standard values of the cycle times of the processes 1 to 5 are 250 sec, the bubble charts of the processes 2, 3, 4, and 5 are similar in having many distributions on the side where the cycle time is longer than the standard value. Therefore, the possibility that these processes are linked can be conceived.

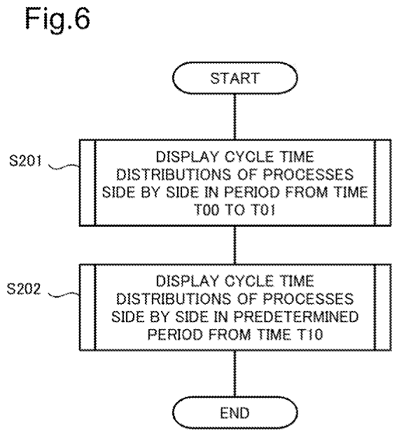

Next, an operation of comparing the cycle time distributions acquired in different time zones will be described. FIG. 6 is a flowchart illustrating this operation. First, the cycle time distributions of the processes in the period from time T00 to time T01 are displayed side by side (S201). Note that predefined processing of S201 is similar to the processing of the flowchart of FIG. 4. Similarly, the cycle time distributions of the processes in the period from time T10 to time T11 are displayed side by side (S202). Here, T01−T00=T11−T10. In the above description, the operation of calculating the cycle time distributions of the processes in the two different periods has been described, but it is also possible to calculate and compare the cycle time distributions in three or more different periods.

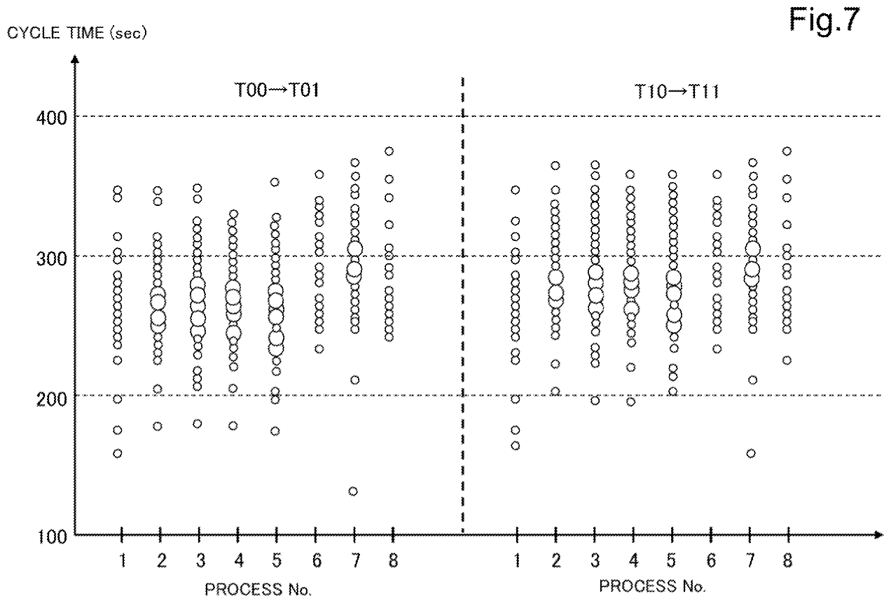

FIG. 7 is a graph illustrating an example of displaying the cycle time distributions in the period from T00 to T01 and the cycle time distributions in the period from T10 to T11 side by side. By comparing the distributions having a time difference in this manner, it is possible to easily find processes in which the distributions change in a linked manner. For example, it is possible to find a possibility that the processes 2 to 5 operate in a linked manner due to the similarity of the shapes of the bubble charts even if the periods for calculating the distributions are different. Note that, in the above description, the example of displaying the cycle time distributions in the two different periods side by side has been described. However, the distributions in three or more different periods may be simultaneously displayed. Alternatively, animation display in which the cycle time distributions in different periods are sequentially displayed can be performed. In addition, the range for calculating the distributions may be set not by the period but by the number of processed workpieces.

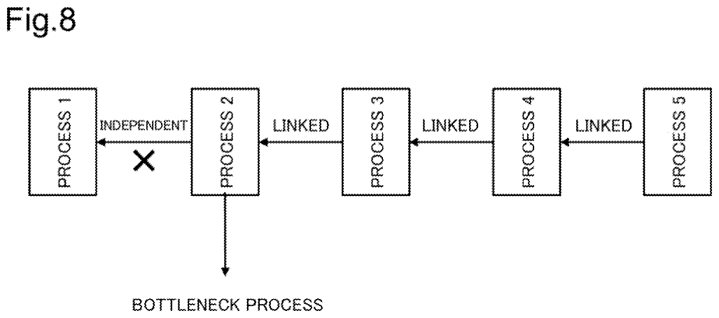

As described above, the process in which the distributions are linked is considered to be dependent on the previous process of its own process. This concept is illustrated in the schematic diagram of FIG. 8. FIG. 8 illustrates that the process 2 is irrelevant to, that is, independent of the process 1, the process 3 is linked to the process 2, the process 4 is linked to the process 3, and the process 5 is linked to the process 4. In such a case, it is obvious that sufficient results cannot be obtained even if only the subsequent processes are improved unless the first process of the linkage is improved. That is, the process at the beginning of the linkage can be considered to be a bottleneck process by tracing back the linkage, and the subsequent entire processes can be improved by improving the bottleneck process.

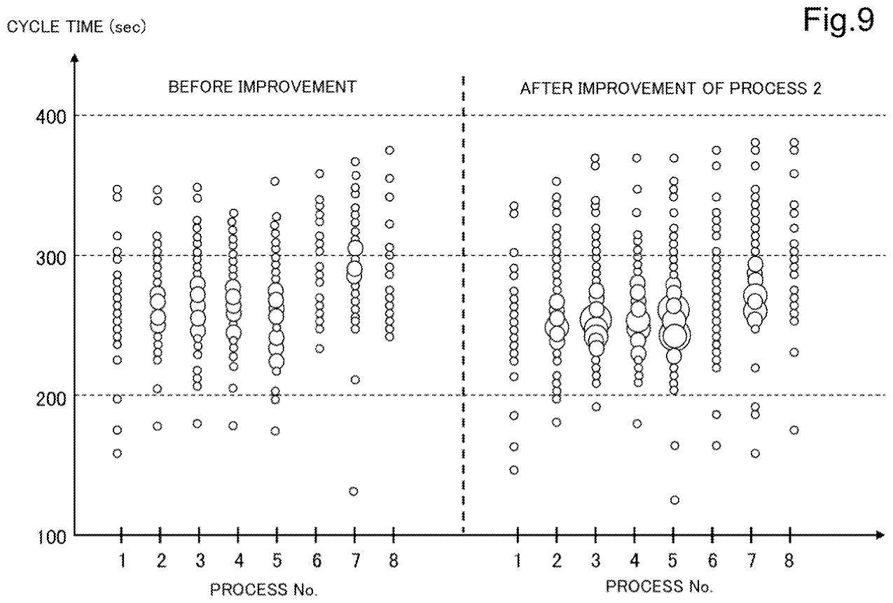

FIG. 9 is a graph illustrating an example of displaying the cycle time distributions before improvement and after improvement in a case of estimating that the processes 2 to 5 are linked and improving the process 2 from the display of FIG. 7. By bringing the cycle time of the process 2 close to the standard value (here, 250 sec), the number of frequencies close to the standard value also increases in the cycle time distributions of the processes 3 to 5.

As described above, according to the present example embodiment, the bottleneck process can be found with high probability by evaluating the correlation of the cycle time distributions of the processes.

### Third Example Embodiment

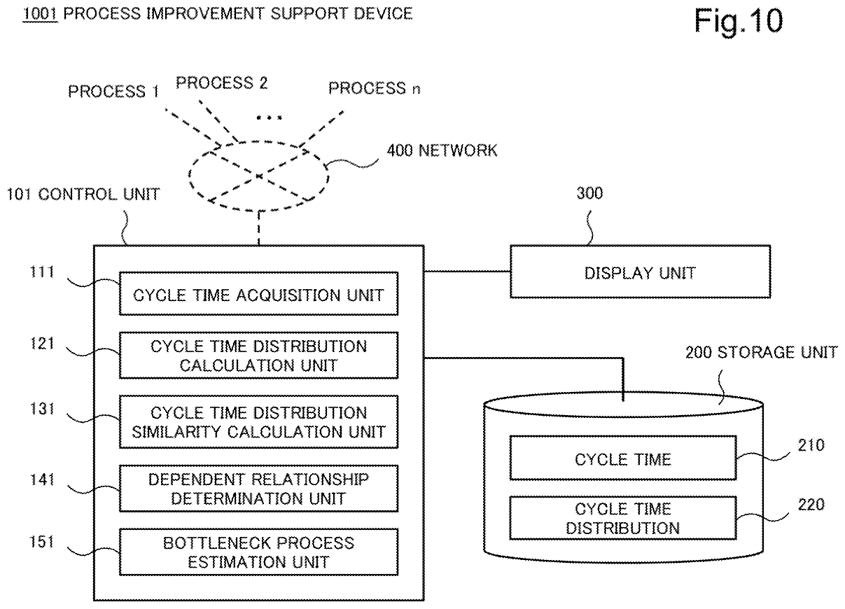

In the second example embodiment, the correlation among the processes has been evaluated by displaying the cycle time distributions of the processes side by side, but the correlation can also be quantitatively evaluated using a mathematical expression. FIG. 10 is a block diagram illustrating a process improvement support device 1001 that performs such quantitative evaluation. The process improvement support device 1001 includes a control unit 101, a storage unit 200, and a display unit 300. The storage unit 200 and the display unit 300 are similar to those of the second example embodiment.

The control unit 101 includes a cycle time acquisition unit 111, a cycle time distribution calculation unit 121, a cycle time distribution similarity calculation unit 131, a dependent relationship determination unit 141, and a bottleneck process estimation unit 151.

The cycle time acquisition unit 111 and the cycle time distribution calculation unit 121 operate similarly to the second example embodiment.

The cycle time distribution similarity calculation unit 131 calculates a similarity between a cycle time distribution of a certain process and a cycle time distribution of a next process. A specific calculation method will be described below.

The dependent relationship determination unit 141 determines whether there is a dependent relationship between two consecutive processes on the basis of the similarity.

The bottleneck process estimation unit 151 estimates a bottleneck process on the basis of the dependent relationship. Although details will be described below, a head process is the bottleneck process in a processing order of processes having a continuous dependent relationship.

Next, a specific example of similarity evaluation will be described.

(1) Comparison of Characteristic Amounts of Distributions

For example, a dissimilarity is calculated by the following expression, where, in processes 0 and 1 to be compared, average values of cycle times of the respective processes are Ym₀ and Ym₁, standard deviations of distributions of the cycle times of the respective processes are σ₀ and σ₁, and a constant is c.

(The dissimilarity)={Ym₁−Ym₀}+c·(σ₁−σ₀) (Expression 1)

Then, the processes having the dissimilarity that is smaller than a to threshold value are determined to be in the dependent relationship. The standard deviations may be dispersed.

(2) Comparison of Total Values of Differences for Each Time Section of Distributions

For example, a dissimilarity is calculated by the following expression, where, in the processes 0 and 1 to be compared, a time segment of the cycle time is represented by tᵢ (i is an integer of 1 or more and n or less, and n is the number of time segments of the cycle time), and frequencies of the cycle times of the respective processes at the time segment tᵢ are Y₁(tᵢ) and Y₀(tᵢ).

(The dissimilarity)=Σᵢ|Y₁(tᵢ)−Y₀(tᵢ)| (Expression 2)

Then, the processes having the dissimilarity that is smaller than a threshold value are determined to be in the dependent relationship.

(3) Comparison of Cross-Correlation of Distributions

For example, in the processes 0 and 1 to be compared, the cross-correlation is calculated by the following expression.

(The Cross-Correlation)=Σᵢ{Y₁(tᵢ) −Ym₁}{(Y₀(tᵢ)−Ym₀}/nσ₁σ₀ (Expression 3)

Then, the processes having the cross-correlation that is larger than a threshold value are determined to be in the dependent relationship.

(4) Comparison of Cross-Correlation using Multi-Dimensional Vectors

For example, in the processes 0 and 1 to be compared, n-dimensional vectors of the respective processes having the frequency of the cycle time for each time section as a component are Y₁ and Y₂. Then, the cross-correlation is calculated by the following expression.

(The cross-correlation)=Y₁·Y₀/(|Y₁∥Y₀|) (Expression 4)

Then, the processes having the cross-correlation that is larger than a threshold value are determined to be in the dependent relationship.

(5) Comparison of Degree of Coincidence of Shapes of Distributions

It is also possible to determine the similarity by the degree of coincidence of shapes of distributions, ignoring the magnitude of the cycle time. For example, in the processes 0 and 1 to be compared the following expressions are calculated while changing j (j is an integer equal to or more than 0 and equal to or less than n−1) by 1. Here, Y₁ⱼ is a vector in which the positions of respective components are shifted by j in the above-described n-dimensional vector Y₁.

(The minimum value of the dissimilarity)=minⱼΣᵢ|Y₁(tᵢ₊ⱼ)−Y₀(tᵢ)| (Expression 5)

(The maximum value of the cross-correlation)=maxⱼY₁ⱼ·Y₀/(|Y₁ⱼ∥Y₀|) (Expression 6)

The processes having the minimum value of the difference in Expression 5 that is smaller than a threshold value and having the maximum value of the cross-correlation in Expression 6 that is larger than a threshold value are determined to be in the dependent relationship.

The similarity between the cycle time distributions of the two processes can be evaluated using the above-described mathematical expressions, and the presence or absence of the dependent relationship can be determined. Then, in the case where the two processes are in the dependent relationship, whether the processes are further dependent on the previous process is determined as illustrated in FIG. 8. By tracing back the dependent relationship in this manner, it is possible to specify the bottleneck process that is a cause of adversely affecting the cycle time.

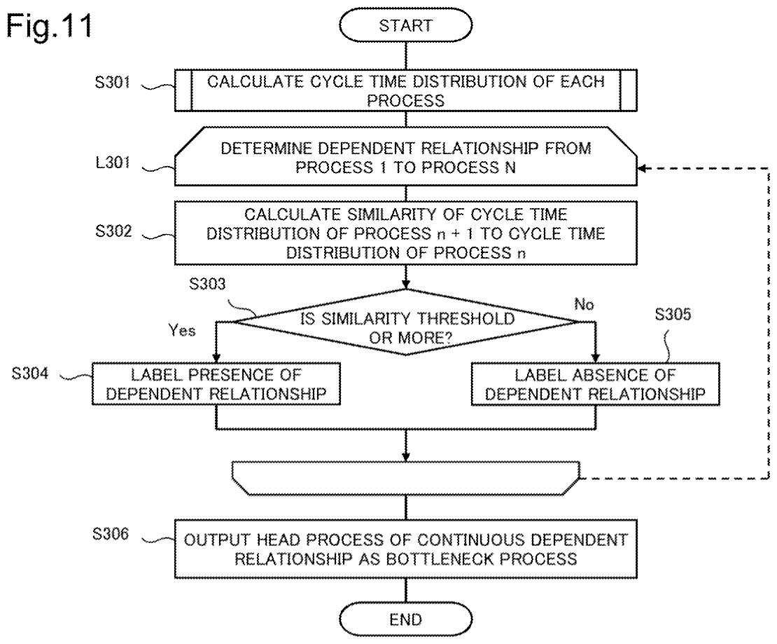

FIG. 11 is a flowchart summarizing the above operation. First, the cycle time distribution of each process is calculated (S301). This predefined processing corresponds to the processing from S101 to S103 of the flowchart of FIG. 4. Next, the presence or absence of the dependent relationship between adjacent processes is sequentially determined for all the processes (the process 1 to the process N) (L301). In this processing, first, the similarity between the cycle time distribution of the process n+1 (n=1 to N) and the cycle time distribution of the process n is calculated (S302). Note that, in the case of determining the similarity by calculating the difference, processing such as replacing a reciprocal of the difference with the similarity may be performed. Here, in the case where the similarity is equal to or larger than the threshold value (S303_Yes), labeling the process n+1 to be dependent on the process n is performed (S304). On the other hand, in the case where the similarity is less than the threshold value (S303_No), labeling the process n+1 to be irrelevant to the dependent relationship is performed (S305). When the presence or absence of the dependent relationship can be determined for all the processes, a group having a continuous dependent relationship is extracted, the head process of each group is specified as the bottleneck process, and a result is output (S306). As described above, the bottleneck process can be specified.

As described above, according to the present example embodiment, the correlation between processes can be evaluated and the bottleneck process can be specified.

A program for causing a computer to execute the processing according to the first to third example embodiments and a recording medium storing the program are also included in the scope of the present disclosure. As the recording medium, for example, a magnetic disk, a magnetic tape, an optical disk, a magneto-optical disk, a semiconductor memory, or the like can be used.

The present disclosure has been described with reference to the above-described example embodiments as exemplary examples. However, the present disclosure is not limited to the above-described example embodiments. That is, various aspects that will be understood by those of ordinary skill in the art can be applied without departing from the spirit and scope of the present disclosure as defined by the claims.

This application is based upon and claims the benefit of priority from Japanese patent application No. 2019-005920, filed on Jan. 17, 2019, the disclosure of which is incorporated herein in its entirety by reference.

### REFERENCE SIGNS LIST

1 Cycle time accumulation means

2 Cycle time distribution calculation means

3 Cycle time distribution correlation evaluation support means

100, 101 Control unit

110, 111 Cycle time acquisition unit

120, 121 Cycle time distribution calculation unit

130 Cycle time distribution parallel display control unit

131 Cycle time distribution similarity calculation unit

140 Time-series display control unit

141 Dependent relationship determination unit

151 Bottleneck process estimation unit

200 Storage unit

210 Cycle time

220 Cycle time distribution

300 Display unit

400 Network

1000, 1001 Process improvement support device

What is claimed is:

1. A process improvement support device comprising:
at least one memory configured to store instructions; and
at least one processor configured to execute the instructions to:
accumulate cycle times of a plurality of processes constituting in a production line over a predetermined period;
calculate a cycle time distribution that is a distribution of the cycle times of each of the processes in the predetermined period; and
generate information for evaluating a correlation between the cycle time distribution of a first process and the cycle time distribution of a second process.

2. The process improvement support device according to claim 1, wherein the at least one processor is further configured to execute the instructions to:
perform control to display, as information for evaluating the correlation, the cycle time distributions of each of the processes in parallel.

3. The process improvement support device according to claim 2, wherein the at least one processor is further configured to execute the instructions to:
perform control to display, as information for evaluating the correlation, a time-series transition of the cycle time distributions.

4. The process improvement support device according to claim 1, wherein the at least one processor is further configured to execute the instructions to:
calculate a quantitative similarity between the cycle time distribution of the second process and the cycle time distribution of the first process.

5. The process improvement support device according to claim 4, wherein the at least one processor is further configured to execute the instructions to:
determine presence or absence of a dependent relationship between the second process and the first process based on the similarity, and
estimate a bottleneck process based on the dependent relationship.

6. A process improvement support method comprising:
accumulating cycle times of a plurality of processes in a production line over a predetermined period;
calculating a cycle time distribution that is a distribution of the cycle times of each of the processes in the predetermined period; and
generating information for evaluating a correlation between the cycle time distribution of a first process and the cycle time distribution of a second process.

7. The process improvement support method according to claim 6, further comprising:
displaying the cycle time distributions of each of the processes in parallel.

8. The process improvement support method according to claim 6, further comprising:
quantitatively calculating a similarity between the cycle time distribution of the second process and the cycle time distribution of the first process.

9. The process improvement support method according to claim 8, further comprising:
determining presence or absence of a dependent relationship between the second process and the first process based on the similarity; and
estimating a bottleneck process based on the dependent relationship.

10. A non-transitory recording medium storing a process improvement support program for causing a computer to execute:
processing of accumulating cycle times of a plurality of processes in a production line over a predetermined period;
processing of calculating a cycle time distribution that is a distribution of the cycle times of each of the processes in the predetermined period; and
processing of generating information for evaluating a correlation between the cycle time distribution of a first process and the cycle time distribution of a second process.
